(19) United States
(12) Patent Application Publication
(10) Pub. No.: US 2010/0069800 A1
(43) Pub. Date: Mar. 18, 2010

(54) MASSAGE DEVICE

(76) Inventor: CHIH-MING HSU, Yulin (TW)

Correspondence Address: Dr. BANGER SHIA;Int''l Patent Office of Bang Shia, 102 Lindencrest Ct, Sugar Land, TX, 77479-5201, US

(21) Appl. No.: 12/407,660

(22) Filed: Mar. 19, 2009

(30) Foreign Application Priority Data
Sep. 12, 2008 (CN) 200820229359.6

(51) Int. Cl. A61H 15/00

(52) U.S. Cl. 601/112; 601/115

(57) ABSTRACT

A massage device includes an outer casing, a control circuit, a power mechanism, a transmission mechanism, a big rotary disc, a small rotary disc, a massage ball, a big lid, and a small lid. The control circular is disposed in the outer casing. The outer casing has a massage surface and an installation trough. The power mechanism, the transmission mechanism, the big rotary disc and the small rotary disc are disposed in the installation trough. The power mechanism is electrically connected to the control circuit via an electric wire and controlled by the control circuit to operate. The power mechanism brings the big rotary disc and the small rotary disc to spin, respectively, through the transmission mechanism. The small rotary disc has a central shaft secured on the big rotary disc. The small rotary disc is formed with a ball aperture. The massage ball is disposed in the ball aperture. The big lid and the small lid cover the big rotary disc and the small rotary disc. The big lid has a big hole corresponding in position to the small rotary disc. The small lid has a small hole corresponding in position to the massage ball. The small hole has a diameter smaller than that of the massage ball. The massage ball has a portion exposed out of the small hole.

### BACKGROUND OF THE INVENTION

1. Field of the Invention

The present invention relates to a massage device, and more particularly to a multiple-purpose massage device for the neck, the waist, or the feet.

2. Description of the Prior Art

There are many massage machines on the market, such as massage chairs, massage beds, massage bars, foot massage pads, neck massage devices and so on. As shown in FIG. 4, a conventional massage device comprises a power mechanism, a big disc 10, and a small disc 20. The power mechanism is installed in a casing 50. The big disc 10 is provided with balls 30. The small disc 20 is provided with balls 40. In use, the user puts his/her feet on the big disc 10 and the small disc 20. The big disc 10 and the small disc 20 are turned in opposite directions through a transmission mechanism such that the balls 30 and 40 provide a massage effect to the feet. However, this massage device provides a single motion, which doesn't function effectively.

Accordingly, the inventor of the present invention has devoted himself based on his many years of practical experiences to the development of a better and multiple-purpose massage device.

### SUMMARY OF THE INVENTION

The primary objective of the present invention is to provide a better and multiple-purpose massage device.

According to the present invention, there is provided a massage device, comprising an outer casing, a control circuit, a power mechanism, a transmission mechanism, a big rotary disc, a small rotary disc, a massage ball, a big lid, and a small lid; the control circular being disposed in the outer casing; the outer casing having a massage surface and an installation trough; the power mechanism, the transmission mechanism, the big rotary disc and the small rotary disc being disposed in the installation trough, the power mechanism being electrically connected to the control circuit via an electric wire and controlled by the control circuit to operate, the power mechanism bringing the big rotary disc and the small rotary disc to spin, respectively, through the transmission mechanism, the small rotary disc having a central shaft secured on the big rotary disc, the small rotary disc being formed with a ball aperture; the massage ball being disposed in the ball aperture; the big lid and the small lid covering the big rotary disc and the small rotary disc, the big lid having a big hole corresponding in position to the small rotary disc, the small lid having a small hole corresponding in position to the massage ball, the small hole having a diameter smaller than that of the massage ball, the massage ball having a portion exposed out of the small hole.

Preferably, two sets of the transmission mechanism, the big rotary disc, the small rotary disc, the massage ball, the big lid, and the small lid are provided on the massage device, each the transmission mechanism comprising a central gear and two side gears, the two side gears meshing with the big rotary disc to bring the big rotary disc to spin, the central gear being inserted through a central hole of the big rotary disc and meshing with the small rotary disc to bring the small rotary disc to spin, the big rotary disc being provided with three small rotary discs, each of the three small rotary discs being formed with a big ball aperture and a small ball aperture for accommodating massage balls in different sizes, the big lid being formed with three big holes, the small lid being formed two small holes in different sizes.

Preferably, the big rotary disc is provided with a heating device, the heating device comprising a big copper plate, a small copper plate, two electric brushes, and heating lights; the big rotary disc having a bottom formed with a big circular groove and a small circular groove to accommodate the big copper plate and the small copper plate, the big rotary disc having a top formed with a plurality of engaging slots to accommodate the heating lights; the big copper plate and the small copper plate being circular plates in different diameters and located in the big circular groove and the small circular groove, respectively; the installation trough of the outer casing being formed with installation holes for insertion of the two electric brushes; first ends of the two electric brushes being located underneath the installation trough and connected with anode and cathode of the control circuit, respectively, second ends of the two electric brushes being located above the installation trough and connected with the big copper plate and the small copper plate, respectively; the heating lights being connected in series between the big copper plate and the small copper plate and installed on the engaging slots.

When the present invention is in use, the massage surface of the outer casing is attached to a body portion, such as putting both feet on the massage balls. The control circuit controls the power mechanism to operate. The power mechanism brings the big rotary disc and the small rotary disc to spin through the transmission mechanism. Thus, the massage balls revolve along with the big rotary disc and spin along with the small rotary disc, providing a better massage effect.

Embodiments of the present invention will now be described, by way of example only, with reference to the accompanying drawings.

### BRIEF DESCRIPTION OF THE DRAWINGS

FIG. 1 is a perspective view of the present invention;

FIG. 2 is an exploded view of the present invention;

FIG. 3 is another exploded view of the present invention; and

FIG. 4 is a perspective view of a conventional massage device.

### DETAILED DESCRIPTION OF THE PREFERRED EMBODIMENTS

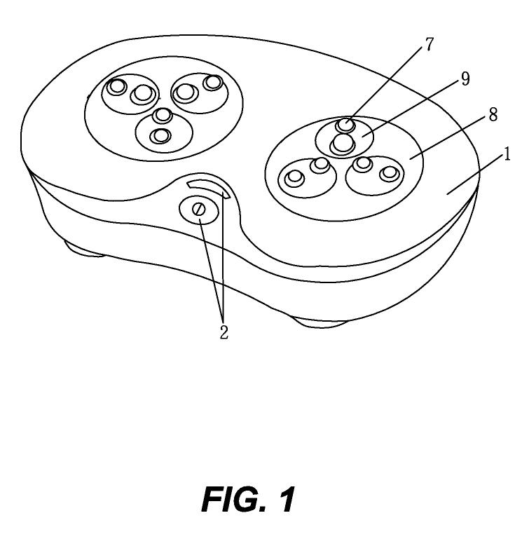

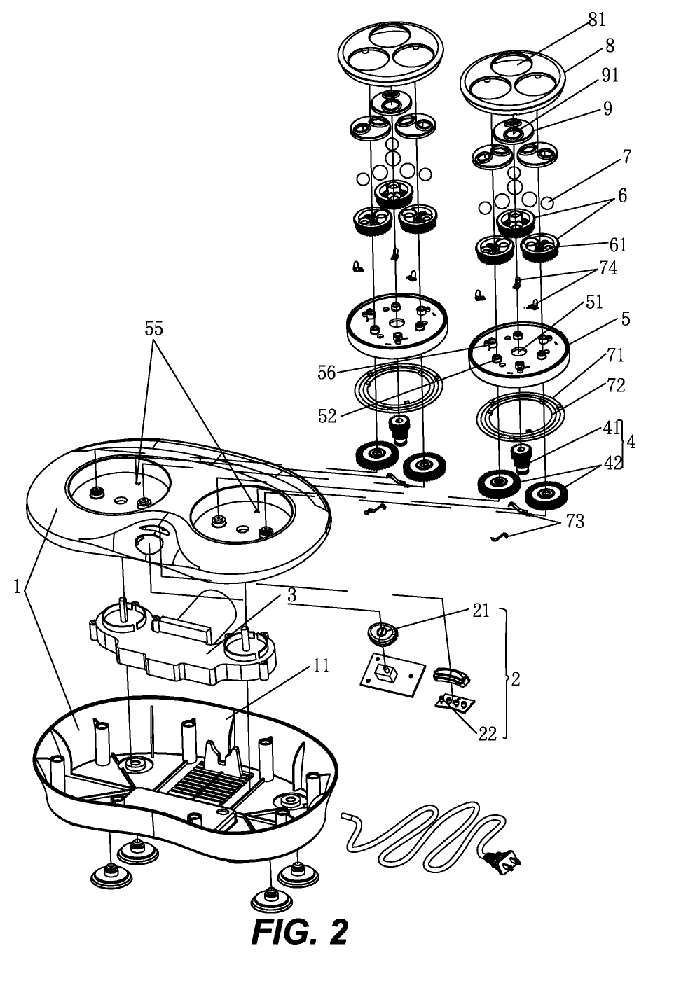

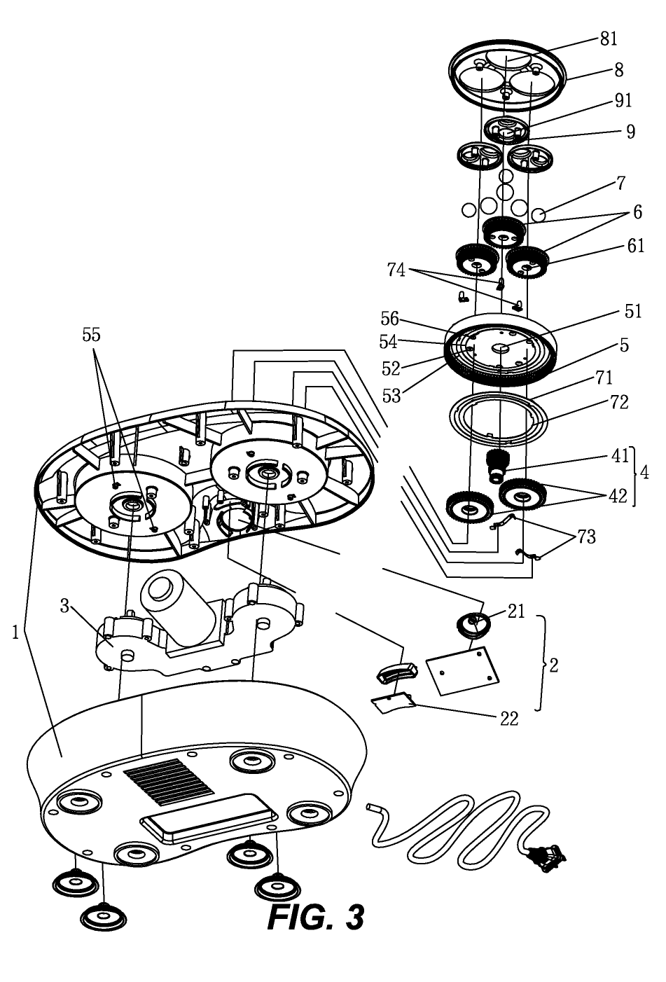

As shown in FIGS. 1 through 3, a massage device according to a preferred embodiment of the present invention comprises an outer casing 1, a control circuit 2, a power mechanism 3, a transmission mechanism 4, a big rotary disc 5, a small rotary disc 6, a massage ball 7, a big lid 8, and a small lid 9.

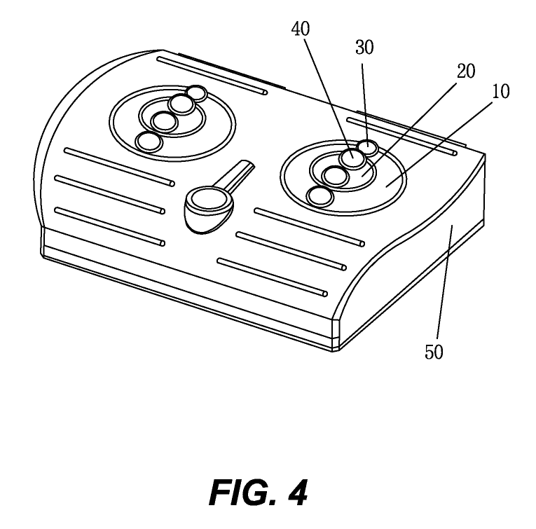

The outer casing 1 is adapted for accommodating other parts of the present invention therein. The outer casing 1 has a massage surface for attaching to a body portion. The massage surface may be designed in a difference shape for attaching to a different body portion, such as a depression for attaching to the neck or the waist, a protrusion for attaching to the foot (as shown in FIG. 4), or other shapes for attaching to other body portions. The outer casing 1 is formed with an installation trough 11 to accommodate the power mechanism 3, the transmission mechanism 4, the big rotary disc 5 and the small rotary disc 6. In order to massage more than one body portion (such as two feet) at the same time, two sets of the transmission mechanism 4, the big rotary disc 5 and the small rotary disc 6 as well as two sets of the massage ball 7, the big lid 8, and the small lid 9 are provided on the massage device.

The control circuit 2 is located in the outer casing 1 for controlling the power mechanism 3 to operate. In order to switch the power and to observe the electricity easily, in this embodiment the control circuit 2 comprises a power switch button 21 and an indicator light 22 which are disposed on the outer casing 1 for convenient control and observation.

The power mechanism 3, the transmission mechanisms 4, the big rotary discs 5 and the small rotary discs 6 are disposed in the installation trough 11. The power mechanism 3 is electrically connected to the control circuit 2 via an electric wire 23, and is controlled by the control circuit 2 to operate. The power mechanism 3 brings the big rotary discs 5 and the small rotary discs 6 to spin, respectively, through the transmission mechanisms 4. Each transmission mechanism 4 comprises a central gear 41 and two side gears 42. The two side gears 42 mesh with inner gear teeth provided at the bottom of the big rotary disc 5 to bring the big rotary disc 5 to spin. The central gear 41 is inserted through a central hole 51 of the big rotary disc 5 and meshes with gear teeth provided at the bottom of the small rotary disc 6 to bring the small rotary disc 6 to spin. The small rotary disc 6 has a central shaft to be secured in a hole 52 of the big rotary disc 5. In order to massage efficiently, there are three small rotary discs 6 disposed on the big rotary disc 5 in this embodiment. The three small rotary discs 6 are simultaneously driven to spin by the central gear 41 of the transmission mechanism 4. Each small rotary disc 6 is formed with a ball aperture 61. The ball aperture 61 corresponds in number and in size to the massage ball 7. In this embodiment, each rotary disc 6 is formed with two ball apertures 61, a big one and a small one, for providing different massage effects.

The massage ball 7 is disposed in the ball aperture 6. The massage ball 7 corresponds in number and in size to the small rotary disc 6. In this embodiment, there are two massage balls 7 disposed on the small rotary disc 6. Furthermore, the two massage balls 7 in different sizes are located in the two ball apertures 61 in different sizes.

The big lid 8 and the small lid 9 cover the big rotary disc 5 and the small rotary disc 6. The big lid 8 has a big hole 81 corresponding in position to the small rotary disc 6. In this embodiment, there are three small rotary discs 6 on the big rotary disc 5, so the big lid 8 is formed with three big holes 81. The small lid 9 has a small hole 91 corresponding in position to the massage ball 7. In this embodiment, the small rotary disc 6 has two ball apertures 61 in different sizes so the small lid 9 is formed with two small holes 91 in different sizes. The diameter of the small hole 91 is smaller than that of a respective massage ball 7. Thus, the massage ball 7 has a portion exposed out of the small hole 91, providing a massage function. The massage ball 7 is confined between the small lid 9 and the small rotary disc 6.

When the present invention is in use, the massage surface of the outer casing 1 is attached to a body portion. In this embodiment, the user puts his/her feet on the massage balls 7. The control circuit 2 controls the power mechanism 3 to operate. The power mechanism 3 brings the big rotary disc 5 and the small rotary disc 6 to spin through the transmission mechanism 4. In this embodiment, there are two sets of the big rotary disc 5 and the small rotary disc 6 with corresponding the massage balls 7, the big lids 8 and the small lids 9. Therefore, the user may put both feet on the massage device. Besides, each big rotary disc 5 has three small rotary discs 6, and each small rotary disc 6 is coupled with a big massage ball 7 and a small massage ball 7, respectively. Each massage ball 7 rolls independently. Each of the three small rotary discs 6 on each big rotary disc 5 spins independently. The three small rotary discs 6 surround the center of the big rotary disc 5 to turn simultaneously while the big rotary disc 5 brings the small rotary discs 6 to spin. Thus, the massage balls 7 revolve along with the big rotary disc 5 and spin along with the small rotary discs 6, providing a better massage effect.

In this embodiment, the big rotary disc 5 is provided with a heating device. The heating device comprises a big copper plate 71, a small copper plate 72, an electric brush 73, and heating lights 74. The bottom of the big rotary disc 5 is formed with a big circular groove 53 and a small circular groove 54. The top of the big rotary disc 5 is formed with a plurality of engaging slots 56. The big copper plate 71 and the small copper plate 72 are circular plates which are located in the big circular groove 53 and the small circular groove 54, respectively. The installation trough 11 of the outer casing 1 is formed with an installation hole 55 for insertion of the electric brush 73. In this embodiment, there are two electric brushes 73 to be installed in two installation holes 55. First ends of the two electric brushes 73 are located underneath the installation trough 11 and connected with the anode and cathode of the control circuit 2, respectively. Second ends of the two electric brushes 73 are located above the installation trough 11 and connected with the big copper plate 71 and the small copper plate 72, respectively. The heating lights 72 are connected in series between the big copper plate 71 and the small copper plate 72 and installed on the engaging slots 56. The heating lights 74 with the big copper plate 71, the small copper plate 72, and the electric brushes 73 are connected with the anode and cathode of the control circuit 2 to form a circuit. When the massage device is in use, the heating lights 74 will generate thermal energy for providing a fomentation effect to the massaged body portion. This helps the blood circulation and enhances the massage effect.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A massage device, comprising an outer casing, a control circuit, a power mechanism, a transmission mechanism, a big rotary disc, a small rotary disc, a massage ball, a big lid, and a small lid; the control circular being disposed in the outer casing; the outer casing having a massage surface and an installation trough; the power mechanism, the transmission mechanism, the big rotary disc and the small rotary disc being disposed in the installation trough, the power mechanism being electrically connected to the control circuit via an electric wire and controlled by the control circuit to operate, the power mechanism bringing the big rotary disc and the small rotary disc to spin, respectively, through the transmission mechanism, the small rotary disc having a central shaft secured on the big rotary disc, the small rotary disc being formed with a ball aperture; the massage ball being disposed in the ball aperture; the big lid and the small lid covering the big rotary disc and the small rotary disc, the big lid having a big hole corresponding in position to the small rotary disc, the small lid having a small hole corresponding in position to the massage ball, the small hole having a diameter smaller than that of the massage ball, the massage ball having a portion exposed out of the small hole.

2. The massage device as claimed in claim 1, wherein two sets of the transmission mechanism, the big rotary disc, the small rotary disc, the massage ball, the big lid, and the small lid are provided on the massage device, each the transmission mechanism comprising a central gear and two side gears, the two side gears meshing with the big rotary disc to bring the big rotary disc to spin, the central gear being inserted through a central hole of the big rotary disc and meshing with the small rotary disc to bring the small rotary disc to spin, the big rotary disc being provided with three small rotary discs, each of the three small rotary discs being formed with a big ball aperture and a small ball aperture for accommodating massage balls in different sizes, the big lid being formed with three big holes, the small lid being formed two small holes in different sizes.

3. The massage device as claimed in claim 1 or claim 2, wherein the big rotary disc is provided with a heating device, the heating device comprising a big copper plate, a small copper plate, two electric brushes, and heating lights; the big rotary disc having a bottom formed with a big circular groove and a small circular groove to accommodate the big copper plate and the small copper plate, the big rotary disc having a top formed with a plurality of engaging slots to accommodate the heating lights; the big copper plate and the small copper plate being circular plates in different diameters and located in the big circular groove and the small circular groove, respectively; the installation trough of the outer casing being formed with installation holes for insertion of the two electric brushes; first ends of the two electric brushes being located underneath the installation trough and connected with anode and cathode of the control circuit, respectively, second ends of the two electric brushes being located above the installation trough and connected with the big copper plate and the small copper plate, respectively; the heating lights being connected in series between the big copper plate and the small copper plate and installed on the engaging slots.
